(19) United States
(12) Patent Application Publication
(10) Pub. No.: US 2025/0383182 A1
(43) Pub. Date: Dec. 18, 2025

(54) RADAR SENSOR CONCEPT FOR MULTI-SENSOR MISSILE APPLICATIONS

(71) Applicant: MBDA Deutschland GmbH, Schrobenhausen (DE)

(72) Inventor: Daniel HAAS, Schrobenhausen (DE)

(73) Assignee: MBDA Deutschland GmbH, Schrobenhausen (DE)

(21) Appl. No.: 19/234,412

(22) Filed: Jun. 11, 2025

(30) Foreign Application Priority Data
Jun. 12, 2024 (DE) 102024001908

(51) Int. Cl. F41G 7/22; G01S 13/88

(52) U.S. Cl. CPC F41G 7/2246; F41G 7/2286; G01S 13/883

(57) ABSTRACT

Disclosed is an antenna array for detecting and/or tracking one or more objects. The antenna array comprises a receiving antenna array having antenna elements for receiving a signal, wherein the receiving antenna array is arranged in a first one-dimensional array. The antenna array further comprises a transmitting antenna array having antenna elements for transmitting the signal, wherein the transmitting antenna array is arranged in a second one-dimensional array which is different from the first one-dimensional array.

### TECHNICAL FIELD OF THE INVENTION

The invention relates to an antenna array that forms a transmitting and receiving antenna array with angular resolution on the edges of narrow surfaces, in particular a transmitting and receiving antenna array on a plurality of control surfaces of a missile for detecting and/or tracking an object.

### BACKGROUND OF THE INVENTION

In conventional systems, for detecting one or more objects and/or for tracking these objects, there are used several adaptive electronically steerable arrays (ASEAs) that are configured to transmit (transmit, Tx) high-frequency radar signals and to receive (receive, Rx) (reflected) radar signals.

The US 2016/0084623 A1 discloses an AESA system comprising a plurality of AESAs each comprising a plurality of radiating elements, each AESA configured for placement on a forward-facing surface of a control surface of a missile.

A plurality of two-dimensional AESAs can result in complex electronics that are difficult to integrate into compact systems. In addition, conventional arrays operate at high frequencies to achieve high angular resolution. Operating at high frequencies can lead to reduced range when detecting and/or tracking one or more objects.

Therefore, it would be desirable to provide an antenna array that enables a high angular resolution, whereas at the same time the costs for the production as well as the efforts for the integration and/or the operation of the antenna array are to be reduced. An operation with lower frequencies would also be desirable.

### SUMMARY OF THE INVENTION

The invention is defined by the independent claims. The dependent claims define advantageous embodiments.

According to a first aspect of the invention, an antenna array for detecting and/or tracking one or more objects comprises a receiving antenna array having antenna elements for receiving a signal, wherein the receiving antenna array is arranged in a first one-dimensional array. The antenna array further comprises a transmitting antenna array having antenna elements for transmitting the signal, wherein the transmitting antenna array is arranged in a second one-dimensional array which differs from the first one-dimensional array.

According to a further development, the first one-dimensional array has the shape of an edge of a control surface of a missile. The first one-dimensional array is preferably a linear array.

According to a further development, the second one-dimensional array has the shape of an edge of a control surface of the missile. The second one-dimensional array is preferably a linear array.

According to a further development, the first one-dimensional array and the second one-dimensional array form an angle in the range between 45° and 135°. According to a further development, the first one-dimensional array and the second one-dimensional array are arranged orthogonally to each other.

According to a further development, the antenna array comprises only the receiving antenna array and the transmitting antenna array.

According to a further development, the receiving antenna array comprises a first plurality of antenna elements and a third plurality of antenna elements.

According to a further development, the transmitting antenna array comprises a second plurality of antenna elements and a fourth plurality of antenna elements.

According to a further development, the antenna elements of the transmitting antenna array are configurable to transmit phase-synchronized signals to generate a common directional antenna lobe.

According to a further embodiment, the antenna elements of the transmitting antenna array are configurable to transmit orthogonal signals in pairs.

According to a first aspect of the invention, a missile comprises a plurality of control surfaces and the antenna array as described above. The receiving antenna array and the transmitting antenna array are arranged on different control surfaces of the plurality of control surfaces.

According to a further development, the missile further comprises an infrared sensor for detecting and/or tracking the object.

According to a further development, the first plurality of antenna elements is arranged on an edge of a first control surface.

According to a further development, the second plurality of antenna elements is arranged on an edge of a second control surface.

According to a further development, the third plurality of antenna elements is arranged on an edge of a third control surface.

According to a further development, the fourth plurality of antenna elements is arranged on an edge of a fourth control surface.

According to a further development, the control surfaces of the plurality of control surfaces can be folded out in a telescopic manner, by rotating about an axis in the flight direction of the missile, or about an axis orthogonal to the flight direction.

According to a further development, the control surfaces have a thickness of five millimeters or less.

Further advantageous embodiments and further developments are shown in the dependent claims and in the description with reference to the figures.

### BRIEF DESCRIPTION OF THE DRAWINGS

The invention is explained in more detail below with reference to the following figures.

FIG. 1 shows an exemplary embodiment of an antenna array on edges of control surfaces of a missile in a top view (′) and a side view (″).

FIG. 2 shows a missile with an exemplary embodiment of a first antenna array on a front plurality of control surfaces on the missile and/or a second antenna array on a rear plurality of control surfaces on the missile.

FIG. 3 shows examples of antenna lobes of the transmitting antennas (Tx antenna lobe, Fₓ), the receiving antennas (Rx antenna lobe, F_{y}) and their superposition (Tx-Rx antenna lobe, F_{xy}) on a hemisphere (ϕ, θ) in, for example, the direction of flight (z) of the missile in FIG. 2.

The accompanying figures are intended to convey a further understanding of the embodiments of the invention. They illustrate embodiments and, in connection with the description, serve to explain principles and concepts of the invention. Other embodiments and many of the advantages mentioned will be apparent with reference to the drawings. The elements shown in the drawings are not necessarily shown to scale with respect to each other. Directional terminology such as “top”, “bottom”, “left”, “right”, “above”, “below”, “horizontal”, “vertical”, “front”, “back”, and similar descriptions are used only for explanatory purposes and are not intended to limit the general nature of the features shown in the figures.

In the figures, the same reference sings denote identical or functionally identical components, unless otherwise indicated.

### DETAILED DESCRIPTION OF EXEMPLARY EMBODIMENTS OF THE INVENTION

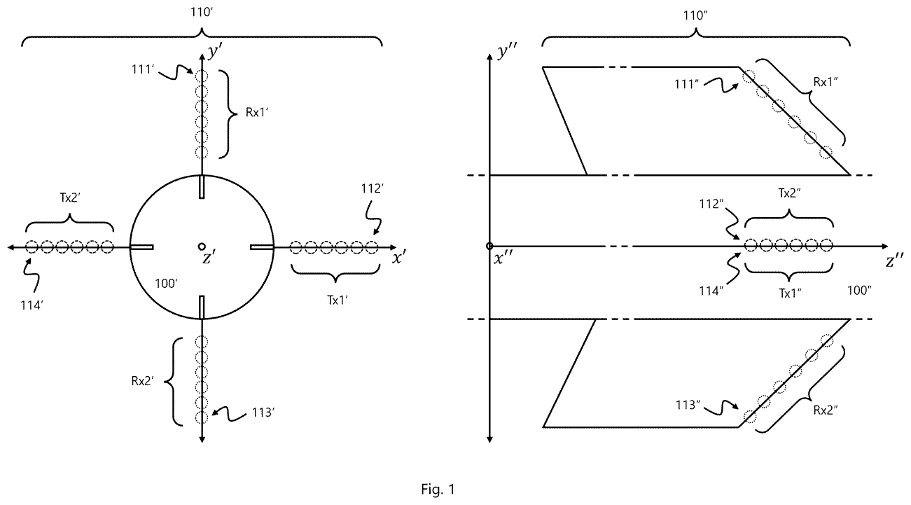

FIG. 1 shows an exemplary embodiment of an antenna array on edges of a plurality 110 of control surfaces of a missile 100 in a top view (′) and a side view (″). The antenna array can also be arranged on other narrow surfaces.

As shown in the example, the plurality 110 of control surfaces may be arranged symmetrically about an axis in the longitudinal direction of the missile 100 on the missile 100. An array with less symmetry or an asymmetrical array is also possible. The symmetry of the array can be used, for example, to simplify the determination of the radiation pattern of identical antenna elements of the array based on a radiation pattern of a single reference antenna element of the array.

The control surfaces can be arranged foldably on the missile 100. The control surfaces can be folded out in a telescopic manner, by rotating them about an axis in the direction of flight or about another axis which is, for example, orthogonal to the direction of flight, as shown, for example, in FIG. 1 by recesses for the control surfaces. The control surfaces can have a thickness of 5 millimeters or less.

The antenna array is arranged on the plurality 110 of control surfaces, for example on 3, 4, 5, 6 or more control surfaces. The antenna array comprises a plurality Rx1, Tx1, Rx2, and/or Tx2 of antenna elements 111, 112, 113, and/or 114.

One, two, or more of the plurality 110 of control surfaces on the missile 100 may be free of antenna elements. In other words, it is not necessary for each control surface of the plurality 110 of control surfaces to comprise an antenna element.

A first control surface may comprise the plurality Rx1 of antenna elements 111. A second control surface may comprise the plurality Tx1 of antenna elements 112. A third control surface may comprise the plurality Rx2 of antenna elements 113. A fourth control surface may comprise the plurality Tx2 of antenna elements 114.

The plurality Rx1 of antenna elements 111 and the plurality Rx2 of antenna elements 113 may also be arranged on a single control surface. Alternatively, or additionally, the plurality Tx1 of antenna elements 112 and the plurality Tx2 of antenna elements 114 may also be arranged on a single control surface.

The plurality Rx1 of antenna elements 111 and the plurality Rx2 of antenna elements 113 may together comprise 2, 3, or N antenna elements, wherein N is an integer greater than 3. The plurality Tx1 of antenna elements 112 and the plurality Tx2 of antenna elements 114 may together comprise 2, 3, or M antenna elements, wherein M is an integer greater than 3.

The plurality Rx1 of antenna elements 111 may be arranged on an edge of the first control surface. The plurality Rx1 of antenna elements 111 can be arranged one-dimensionally, for example along an edge, in particular linearly. The antenna elements 111 of the plurality Rx1 can be identical and/or have a distance from each other that is identical for neighboring antenna elements. The first control surface may comprise only the plurality Rx1 of antenna elements 111. The plurality Rx1 of antenna elements 111 may be configured for transmitting and receiving. In particular, the plurality Rx1 of antenna elements 111 may be configured exclusively for receiving.

The plurality Tx1 of antenna elements 112 may be arranged on an edge of the second control surface. The plurality Tx1 of antenna elements 112 can be arranged one-dimensionally, for example along an edge, in particular linearly. The antenna elements 112 of the plurality Tx1 may be identical and/or have a distance from each other that is identical for neighboring antenna elements. The second control surface may comprise only the plurality Tx1 of antenna elements 112. The plurality Tx1 of antenna elements 112 may be configured for transmitting and receiving. In particular, the plurality Tx1 of antenna elements 112 may be configured exclusively for transmitting.

The plurality Rx2 of antenna elements 113 may be disposed on an edge of the third control surface. The plurality Rx2 of antenna elements 113 can be arranged one-dimensionally, for example along an edge, in particular linearly. The antenna elements 113 of the plurality Rx2 may be identical and/or have a distance from each other that is identical for neighboring antenna elements. The third control surface may comprise only the plurality Rx2 of antenna elements 113. The plurality Rx2 of antenna elements 113 may be configured for transmitting and receiving. In particular, the plurality Rx3 of antenna elements 113 may be configured exclusively for receiving.

The plurality Tx2 of antenna elements 114 may be disposed on an edge of the fourth control surface. The plurality Tx2 of antenna elements 114 can be arranged one-dimensionally, for example along an edge, in particular linearly. The antenna elements 114 of the plurality Tx2 may be identical and/or have a spacing from each other that is identical for neighboring antenna elements. The fourth control surface may comprise only the plurality Tx2 of antenna elements 114. The plurality Tx2 of antenna elements 114 may be configured for transmitting and receiving. In particular, the plurality Tx2 of antenna elements 114 may be configured exclusively for transmitting.

The first control surface and the third control surface may be substantially in a first plane. The second control surface and the fourth control surface may be substantially in a second plane. The first plane and the second control surface may be substantially orthogonal to each other.

The above arrays of antenna elements are exemplary; they can be implemented analogously on 3, 5, 6 or more control surfaces.

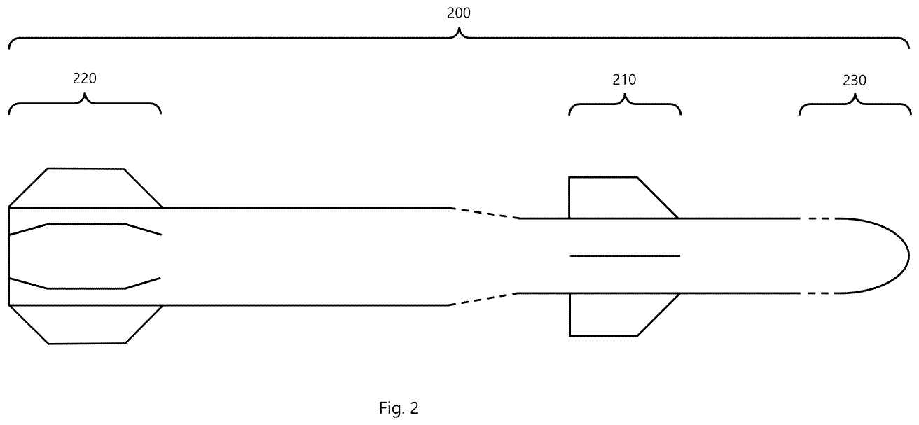

FIG. 2 shows a missile 200 with an exemplary embodiment of a first antenna array on a front plurality 210 of control surfaces on the missile 200 and/or a second antenna array on a rear plurality 220 of control surfaces on the missile 200.

The missile 200 can, for example, have a diameter in the range between 120 mm and 150 mm without control surfaces. With control surfaces, the diameter can be up to 500 mm. The missile 200 can have a modular structure to facilitate transportation or manipulation for firing. The missile 200 may further have a length in the range between, for example, 1000 mm and 4000 mm. The first antenna array and/or the second antenna array may be substantially identical to the antenna array shown in FIG. 1. Preferably, the missile 200 comprises only a single antenna array.

The missile 200 may comprise an infrared sensor for detecting and/or tracking an object, hereinafter also referred to as an infrared seeker head. The missile 200 may be configured to detect several objects by means of the infrared sensor and an antenna array as described above.

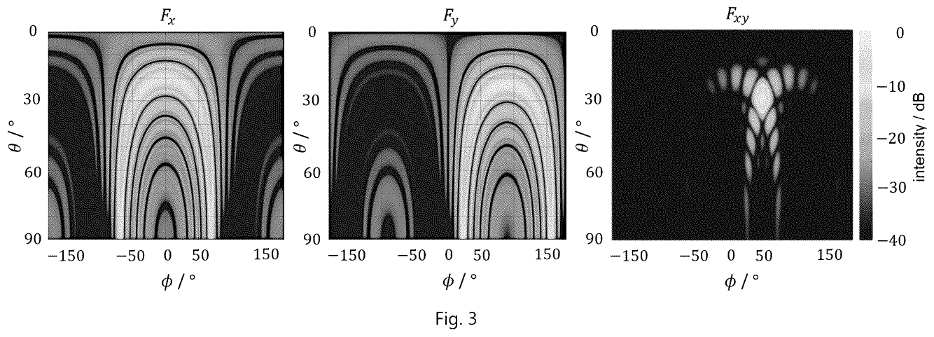

FIG. 3 shows examples of antenna lobes of transmitting antennas (Tx antenna lobe, Fₓ), of receiveing antennas (Rx antenna lobe, F_{y}) and their superposition (Tx-Rx antenna lobe, F_{xy}) on a hemisphere (ϕ, θ) in, for example, the direction of flight (z) of the missile in FIG. 2.

As shown, for detecting and/or tracking an object, by combining Tx and Rx antenna elements, there can be formed a Tx/Rx pattern.

With the antenna arrays described above, there exists the possibility of electronic beam alignment of the Tx-Rx antenna lobe in three-dimensional space.

Thanks to the separate arrangement of transmitting and receiving antenna elements, the complexity of the system can be significantly reduced. Operation at lower frequencies is made possible.

In operation, for example, the first plurality Tx1 of antenna elements 111 and/or the second plurality Tx2 of antenna elements 113, hereinafter referred to as the transmitting antenna array (Tx1 and/or Tx2), can transmit radar signals, while the second plurality Rx1 of antenna elements 112 and/or the fourth plurality Rx2 of antenna elements 114, hereinafter referred to as the receiving antenna array (Rx1 and/or Rx2), receive these radar signals, for example after a reflection from an object which is to be detected and/or tracked.

The individual antenna elements of the transmitting antenna array (Tx1 and/or Tx2) can a) emit phase-synchronized signals and thus generate a common directional Tx antenna lobe.

The individual antenna elements of the transmitting antenna array (Tx1 and/or Tx2) can b) each radiate orthogonal signals and thus allow MIMO operation (multiple input multiple output, MIMO) with N orthogonal Tx signals

The individual antenna elements of the transmitting antenna array (Tx1 and/or Tx2) can c) radiate orthogonal signals arranged in k sub-arrays n₁ to nₖ with n₁ +. . . +nₖ=N and thus permit MIMO operation with k orthogonal Tx signals.

The receiving signals of the M individual antenna elements of a receiving antenna array (Rx1 and/or Rx2) can be combined in analog and/or digital form to process the combined signals for detecting and/or tracking an object.

In the preceding detailed description, various features have been summarized in one or more examples to improve the stringency of the illustration. However, it should be clear in this respect that the above description is merely illustrative and in no way limiting in nature. It is intended to cover all alternatives, modifications and equivalents of the various features and exemplary embodiments. Many other examples will be immediately and directly obvious to a skilled person in view of the above description.

The exemplary embodiments have been selected and described in order to best illustrate the principles underlying the invention and its possible applications in practice. As a result, skilled persons can optimally modify and use the invention and the various exemplary embodiments thereof in relation to the intended use. In the claims as well as in the description, the terms “including” and “having” are used as neutral language terms for the corresponding terms “comprising”. Furthermore, the use of the terms “a”, “an” and “one” is not intended to fundamentally exclude a plurality of features and components described in such a manner.

### LIST OF REFERENCE SIGNS

### Reference Signs

100 missile
110 plurality of control surfaces
Tx1 first plurality of antenna elements of the transmitting antenna array
Tx2 third plurality of antenna elements of the transmitting antenna array
Rx1 second plurality of antenna elements of the receiving antenna array
Rx2 fourth plurality of antenna elements of the receiving antenna array
111 antenna elements from Tx1
112 antenna elements from Rx1
113 antenna elements from Tx2
114 antenna elements from Rx2
200 missile
210 first plurality of control surfaces
220 second plurality of control surfaces
230 infrared sensor

1. An antenna array for detecting and/or tracking one or more objects, wherein the antenna array comprises:
a receiving antenna array (Rx1 and/or Rx2) comprising antenna elements (111 and/or 113) for receiving a signal, wherein the receiving antenna array (Rx1 and/or Rx2) is arranged in a first one-dimensional array;
a transmitting antenna array (Tx1 and/or Tx2) comprising antenna elements (112 and/or 114) for transmitting the signal, wherein the transmitting antenna array (Tx1 and/or Tx2) is arranged in a second one-dimensional array which is different from the first one-dimensional array.

2. The antenna array according to claim 1,
wherein the first one-dimensional array has a shape of an edge of a control surface of a missile (100; 200), preferably being a linear array; and/or
wherein the second one-dimensional array has the shape of an edge of a control surface of the missile (100; 200), preferably being a linear array.

3. The antenna array according to claim 1, wherein the first one-dimensional array and the second one-dimensional array form an angle in the range between 45° and 135°, preferably orthogonal to each other.

4. The antenna array according to claim 1, wherein the antenna array comprises the receiving antenna array and the transmitting antenna array.

5. The antenna array according to claim 1,
wherein the receiving antenna array comprises a first plurality (Rx1) of antenna elements (111) and a third plurality (Rx2) of antenna elements (113); and/or
wherein the transmitting antenna array comprises a second plurality (Tx1) of antenna elements (112) and a fourth plurality (Tx2) of antenna elements (114).

6. The antenna array according to claim 1,
wherein the antenna elements (112 and/or 114) of the transmitting antenna array (Tx1 and/or Tx2) are configurable to transmit phase-synchronized signals to generate a common directional antenna lobe; and/or
wherein the antenna elements (112 and/or 114) of the transmitting antenna array (Tx1 and/or Tx2) are configurable to transmit orthogonal signals in pairs.

7. A missile (100; 200), wherein the missile (100; 200) comprises:
a plurality (110; 210, 220) of control surfaces; and
the antenna array according to claim 1;
wherein the receiving antenna array (Rx1 and/or Rx2) and the transmitting antenna array (Tx1 and/or Tx2) are arranged on different control surfaces of the plurality (110; 210, 220) of control surfaces.

8. The missile (100; 200) according to claim 7, wherein the missile (100; 200) further comprises an infrared sensor for detecting and/or tracking the object.

9. The missile (100; 200) according to claim 7,
wherein the first plurality (Rx1) of antenna elements (111) is arranged on an edge of a first control surface;
wherein the second plurality (Tx1) of antenna elements (112) is arranged on an edge of a second control surface;
wherein the third plurality (Rx2) of antenna elements (113) is arranged on an edge of a third control surface; and
wherein the fourth plurality (Tx2) of antenna elements (114) is arranged on an edge of a fourth control surface.

10. The missile (100; 200) according to claim 7, wherein the control surfaces of the plurality (110; 210, 220) of control surfaces can be folded out in a telescopic manner, by rotating about an axis (z) in the flight direction of the missile (100; 200), or about an axis orthogonal to the flight direction, and preferably have a thickness of five millimeters or less.
